(19) United States
(12) Patent Application Publication
(10) Pub. No.: US 2012/0062883 A1
(43) Pub. Date: Mar. 15, 2012

(54) CRYSTALLINE COLLOIDAL ARRAY DEEP UV NARROW BAND RADIATION FILTER

(75) Inventors: Sanford A. Asher, Pittsburgh, PA (US); Luling Wang, Wuhan (CN); David Tuschel, South Plainfield, NJ (US)

(73) Assignee: Sanford A. Asher, Pittsburgh, PA (US)

(21) Appl. No.: 13/227,066

(22) Filed: Sep. 7, 2011

Related U.S. Application Data
(60) Provisional application No. 61/382,551, filed on Sep. 14, 2010.

(51) Int. Cl. G01J 3/44; G01J 3/28; G02B 5/20; C07F 7/18; C08G 77/28

(52) U.S. Cl. 356/301; 556/428; 528/30; 359/350; 356/328

(57) ABSTRACT

The present invention provides a method of making highly charged, monodisperse particles which do not absorb deep ultraviolet (UV) light and a method of making crystalline colloidal array (CCA) deep UV narrow band radiation filters by using these highly charged monodisperse particles. The CCA filter rejects and/or selects particular regions of the electromagnetic spectrum while transmitting adjacent spectral regions. The filtering devices of the present invention are wavelength tunable over significant spectral intervals by changing the incident angle of the CCA filter relative to the light. Larger wavelength changes can be obtained by changing the concentrations of particles in the CCAs. The present invention also includes applications of the CCA filter to hyperspectral imaging and Raman imaging devices.

### CROSS-REFERENCE TO RELATED APPLICATIONS

This application claims the benefit of provisional patent application Ser. No. 61/382,551 filed 2010 Sep. 14 by the present inventors.

### FEDERALLY SPONSORED RESEARCH

The invention described herein was made with government support under Contract No. 1R01EB009089 awarded by the National Institute of Health. Therefore, the government has certain rights in the invention.

### BACKGROUND

### Prior Art

Optical spectroscopy plays an important role in chemical analysis, materials science and in static and dynamic studies of biological structure. Many applications require wavelength-selective optical elements to reject and/or select particular regions of the electromagnetic spectrum while transmitting adjacent spectral regions. Typical examples include fluorescence measurements, Raman spectroscopy and the many pump-probe techniques. These pump-probe techniques excite a sample at a particular wavelength and probe at other wavelengths to monitor absorption changes, for example. Monochromators or filters are used in these applications to select the spectral region to be passed and to reject the pump wavelength when necessary.

For some optical techniques in the deep UV region, such as UV Raman spectroscopy, UV resonance Raman measurements, pump-probe techniques, UV hyperspectral imaging spectrometers, and atomic absorption or emission spectroscopy, it is essential to develop deep UV (190-300 nm) optical transmission and reflection filters that are efficient and compact. It will be especially helpful if these deep UV filters could be wavelength tuned over particular wavelength ranges.

Currently, holographic laser line rejection filters exist that reject laser wavelengths ranging from 320 nm to the near infrared (IR). The widely used holographic filters cannot operate in the deep UV region because the materials contained in these filters strongly absorb deep UV light.

In principle, dielectric interference filters could exist in the deep UV but the necessary deep UV nonabsorbing materials are not readily available and the fabrication process is expensive and complicated. Semrock Inc. (Rochester, N.Y.) recently commercialized a 224.3 nm long wavelength pass (LWP) edge filter by using technology described in U.S. Pat. No. 7,068,430 B1 and U.S. Pat. No. 7,119,960 B1. The Semrock edge filters require a plurality of alternating layers of relatively high index and relatively low index materials (typically more than 100 layers) and a method to control the thickness of each deposited layer. For instance, a steep-edge LWP filter for a 532 nm laser line is made by depositing 180 alternating layers of Ta₂O₅ and SiO₂ on a BK7 glass substrate.

A subtractive dispersion double monochromator could be used as a tunable filter to block specific spectral ranges, but these devices are mechanically complex, large and expensive.

Asher, U.S. Pat. No. 4,627,689 and Asher, U.S. Pat. No. 4,632,517 disclose crystalline colloidal array (CCA) narrow band radiation filters and filtering devices that utilize highly ordered CCA photonic crystals. Charged monodisperse particles can self assemble into CCA in low ionic strength liquid media. This self assembly results from the screened electrostatic repulsion of the charged particles in low ionic strength solutions. To minimize the total electrostatic interparticle repulsion interactions, these charged monodisperse particles self assemble to form well ordered face-centered cubic (FCC) or body-centered cubic (BCC) crystals. CCAs resemble atomic and molecular crystals, but have much larger lattice spacing. As a result, they can strongly Bragg diffract light in the UV, visible and near IR regions. Such arrays can be used as narrow-band optical diffraction filters.

However, no deep UV CCA filter presently exists due to the lack of appropriate colloidal particles; deep UV operation of CCA filters requires monodisperse and highly charged CCA particles that do not absorb deep UV light. Also, the diameters of the particles need to be small since the Bragg diffracted wavelength is in the deep UV range. For Bragg diffracted wavelengths of ˜200 nm, it is desirable that the particle diameter be less than 70 nm.

Few materials permit high transmittance in the deep UV and can be used for the UV optical applications. These include UV grade fused silica, CaF₂, MgF₂, and crystal quartz. Those materials usually have a relatively low refractive index and do not have absorption bands at wavelengths longer than 190 nm.

Asher, U.S. Pat. No. 4,627,689 and Asher, U.S. Pat. No. 4,632,517 discloses particles made with a polystyrene core. Said polystyrene particles strongly absorb deep UV light and have an absorption band at approximately 290 nm. Seker, et al., U.S. Pat. Application 2006/0024847, discloses particles with electromagnetically-functional cores and polymer shells. The disclosure shows electromagnetically-functional core-shell particle arrays that strongly absorb UV light. For instance data in FIG. 10 of the application 2006/0024847 indicates that only 25-40% of light at 300 nm is transmitted through the matrix. Ben-Moshe, et al., U.S. Pat. No. 7,902,272 discloses spheres with polymer shells. The polymer shells or coatings disclosed would absorb deep UV light. Ben-Moshe, et al., U.S. Pat. Application 2008/0064788, disclose particles having high refractive index cores. It may be concluded that high refractive index cores prevent deep UV application since known deep UV transmitting materials have low refractive indices. Kimble, et al., U.S. Pat. Application 2009/0318309 discloses particles that strongly absorb UV light. For example FIG. 5 of the application 2009/0318309, indicates only 10% transmittance of light at 400 nm. None of the above compounds would work as substantially deep UV transparent particles because their compositions contain components which strongly absorb in the deep UV spectrum. See Rife, J. C., “Optical Materials—UV, VUV”, Electro-optics Handbook (2^{nd} Edition), Ed. by Waynant, R. W.; Eidger, M. N., Chapter 10, PP. 10.1-10.46 (McGraw-Hill, 2000).

As seen above, there remains a need for small diameter monodisperse highly charged particles which do not absorb deep UV light and can be used for fabricating CCA deep UV narrow band radiation filters. Such a CCA filter could be used to select and/or reject predetermined wavelengths of UV electromagnetic radiation and could also be wavelength tuned over particular wavelength ranges. There is also a need for these CCA narrow band radiation filters to be used for hyperspectral imaging and for use in Raman spectral imaging systems.

### SUMMARY

These and other needs are satisfied by various aspects of the invention which provide highly charged monodisperse, UV substantially transparent particles, methods of making highly charged monodisperse, UV substantially transparent particles, methods of making CCA deep UV narrow band radiation filters from the particles, and hyperspectral imaging devices. The CCA deep UV narrow band filters can selectively and effectively reject a narrow band of wavelengths from a broader spectrum of incident radiation while transmitting adjacent wavelengths to a high degree.

In accordance with a first aspect, UV filter particles are comprised of a core of a first material that is substantially transparent in the ultraviolet spectrum between about 190 and 300 nm wavelength; a surface functionalization substantially transparent in a portion of the ultraviolet spectrum between about 190 and 300 nm wavelength on the surface of the core, the functionalized surface having a charge of at least 0.5 μC/cm²; and wherein the surface functionalized core particles have an average diameter of between approximately 10 nm and 300 nm. In preferred embodiments of the first aspect, the cores are comprised of silica. In another embodiment, the cores are comprised of magnesium fluoride. In yet another preferred embodiment, the cores are comprised of calcium fluoride.

In accordance with a second aspect, the method of making UV filter particles comprises selecting monodisperse particles comprised of a first material substantially transparent in the ultraviolet spectrum between about 190 and 300 nm wavelength; attaching to the monodisperse particle surfaces a second compound substantially transparent in a portion of the ultraviolet spectrum below 300 nm wavelength, wherein the second compound provides charged groups, and the monodisperse particles after being attached to the second compound will have a charge density of at least 0.5 μC/cm², whereby forming the highly charged, surface functionalized particles substantially transparent in a portion of the ultraviolet spectrum below 300 nm wavelength.

Preferred embodiments of the second aspect have monodisperse particles comprised of silica. Another preferred embodiment of the second aspect has monodisperse particles comprised of calcium fluoride. Still another preferred embodiment of the second aspect has monodisperse particles comprised of magnesium fluoride.

In preferred embodiments of the second aspect, the method further comprises the step of preparing monodisperse particles through hydrolysis and condensation of a silane precursor and a catalyst. In other preferred embodiments, the compound comprises a silanol having one or more hydroxyl groups bonded to the silica. In still another preferred embodiment, the compound comprises 3-(trihydroxysilyl)-1-propane-sulfonic acid. In yet another preferred embodiment, the highly charged, surface functionalized particles have an average diameter of equal or greater than 10 nm and equal or less than 300 nm.

In other preferred embodiments, the method of the second aspect further comprises the steps of cleaning the highly charged, surface functionalized particles by cleaning means to give cleaned particles; treating the cleaned particles with ion exchange resin to give resin treated particles; and self-assembling the resin treated particles, whereby a crystalline colloidal array is formed. In a preferred embodiment, the cleaning means comprises centrifugation and redispersion. In another preferred embodiment, the cleaning means is dialysis. In yet another preferred embodiment, the method further comprises the step of transferring the crystalline colloidal array to a cell, wherein the cell comprises parallel wall members formed of a second material substantially transparent in a portion of the ultraviolet spectrum between about 190 and 300 nm wavelength. In still another preferred embodiment, the method further comprises the step of polymerizing the crystalline colloidal array and a monomer into a polymer, wherein the polymer formed is substantially transparent in the ultraviolet spectrum between about 190 and 300 nm wavelength.

In another preferred embodiment of the second aspect, the method further comprises the steps of passing a beam of ultraviolet light through the cell; observing diffraction of the beam of ultraviolet light; rotating the cell. In another preferred embodiment, the charge density of particles can be tuned by changing the amount of the silane coupling agent.

In a third aspect of the invention, an ultraviolet filter device is comprised of a crystalline colloidal array made by the method of the second aspect in a cell substantially transparent in the portion of the ultraviolet spectrum below 300 nm. In another preferred embodiment, the ultraviolet filter device is comprised of a crystalline colloidal array that Bragg diffracts light and is substantially transparent in a portion of the ultraviolet spectrum between about 190 and 300 nm wavelength in a cell substantially transparent in the portion of the ultraviolet spectrum.

In accordance with another preferred embodiment, a deep UV CCA filter is produced to filter out greater than 99% of a wavelength band at 229 nm while transmitting adjacent wavelengths. The CCA filtering devices are wavelength tunable over significant spectral intervals by adjusting the filter orientation relative to the incident light. Larger wavelength changes can be obtained by changing the concentrations of the CCA particles.

In accordance with another preferred embodiment of the third aspect, the filter is used to reject Rayleigh scattering while transmitting Raman bands of Teflon using deep UV Raman excitation.

In accordance with a fourth aspect of the invention, a CCA filter is used as the wavelength selective optical element of a hyperspectral imaging device. In preferred embodiments of the fourth aspect, the filter devices can be used for Raman, luminescence, transmission, scattering or reflected light hyperspectral imaging.

### DRAWINGS

FIG. 1 is an illustration of the CCA filter described in one example of the present invention.

FIG. 2 demonstrates the theoretical diffraction efficiency of the CCA filter according to one embodiment of the present invention.

FIG. 3 illustrates a hyperspectral image data set of a static object obtained by using a CCA to reflect a series of narrow wavelength bands.

FIG. 4 shows transmission spectra of highly charged silica CCA at different incident glancing angles.

FIG. 5 illustrates a schematic of a triple-stage monochromator and the CCA filter for Raman measurements.

FIG. 6 shows Raman spectra of Teflon with and without using a CCA filter for Rayleigh rejection.

FIG. 7 shows a diagram (I) of a hyperspectral imaging spectrometer that utilizes a CCA deep UV wavelength selecting device that allows wavelength tuning with a stationary camera.

FIG. 8 shows a diagram (II) of a hyperspectral imaging device that utilizes a CCA deep UV wavelength selecting device that allows wavelength tuning with a stationary camera.

FIG. 9 shows a diagram of a hyperspectral imaging device based on transmission through a wavelength selective CCA filter.

FIG. 10 shows a hypothetical “complementary” Raman spectrum of c-Si.

### DETAILED DESCRIPTION OF THE INVENTION

Deep UV narrow band radiation filters are capable of rejecting particular regions of the electromagnetic spectrum while transmitting adjacent spectral regions. Specifically, in one embodiment, the deep UV filters disclosed herein are comprised of highly charged, monodisperse, small silica particles that are substantially transparent in the deep UV range (190-300 nm). These highly charged monodisperse silica particles self assemble into CCAs in low ionic strength liquid media. The CCA can be used as a deep UV narrow band radiation filter for selecting and/or rejecting predetermined wavelength bands of electromagnetic radiation. The CCA can also be used for hyperspectral imaging and Raman imaging applications. The silica CCA described herein is for the purpose of demonstration, and it is evident that other UV transparent particles such as CaF₂, MgF₂ etc. can also be functionalized for CCA fabrication and the related filtering and hyperspectral imaging and Raman imaging applications.

In accordance with a first aspect, UV filter particles are comprised of a core of a first material substantially transparent in the ultraviolet spectrum between about 190 and 300 nm wavelength; a surface functionalization substantially transparent in a portion of the ultraviolet spectrum between about 190 and 300 nm wavelength on the surface of the core, the functionalized surface having a charge of at least 0.5 μC/cm²; and wherein the surface functionalized core particles have an average diameter of between approximately 10 nm and 300 nm. In preferred embodiments of the first aspect, the cores are comprised of silica. In another preferred embodiment, the cores are comprised of magnesium fluoride. In yet another preferred embodiment, the cores are comprised of calcium fluoride.

In accordance with a second aspect of the invention, a method for making these highly charged monodisperse small silica particles generally comprises the steps of synthesizing so-called Stöber silica particles by a modified Stöber method, and attaching a high surface density of substantially UV transparent silane coupling agent to the surface of the small silica particles. For instance, in one embodiment, the Stöber silica particles are synthesized by using tetraethoxysilane as the silica precursor, ammonium hydroxide as the catalyst, and ethanol as the reaction solvent, where tetraethoxysilane can be replaced by tetramethoxyl silane or other silanes with similar structures and the reaction solvent can be any solvent available for the Stöber method. The silane coupling agents herein contain charged groups that are substantially transparent in a portion of the ultraviolet spectrum between about 190 and 300 nm wavelength. For example, in one embodiment, the Stöber silica particles are functionalized with (3-(trihydroxylsilyl)-1-propane-sulfonic acid, THOPS) and the resulting silica particles are highly charged due to the low pKₐ<1 of the surface sulfonic acid groups. Before the surface modification, the pH of the silane coupling agent is adjusted to avoid aggregation of the Stöber silica particles. Other suitable coupling agents with similar functions as that of THOPS can also be used to make said highly charged monodisperse, small particles. The surface modification reaction is heated to favor the hydrolysis and condensation of the coupling agents. The method herein is used to make charged silica particles with diameters from 10 nm to 270 nm. The particle size can be tuned by changing the amount of ammonium hydroxide or precursor during the synthesis of the Stöber silica particles. For Stöber silica particles, see Stöber W. et al., “Controlled Growth of Monodisperse Silica Spheres in the Micron Size Range”, Journal of Colloid and Interface Science, vol. 26 (1968), pp. 62-69.

It is contemplated that the size range may be variable from ˜10 nm to 10 μm. The surface charge of the silica particles can be easily tuned by varying the amount of THOPS during the surface modification. For example, the surface charge of silica particles increased from 2190 to 4740 charges per particle as the amount of THOPS increased from 4 mL to 6 mL for the same amount of Stöber silica particle surface area. Similar charge tenability for silica particles can be also achieved by using other suitable coupling agents mentioned above. It is evident that any UV transparent particles such as CaF₂, MgF₂ etc. can be also functionalized with charged groups in accordance with the embodiment mentioned above.

The charged silica particles should be cleaned by centrifugation and redispersion of the silica particles in pure water or other suitable solvents several times or by dialysis against suitable solvents. Further purification was achieved by shaking the silica dispersion with mixed bed ion-exchange resin (Bio-Rad AG 501-X8) to remove the ionic impurities. After purification, these highly charged silica particles readily self assembled into CCAs. Any UV charged transparent particles such as CaF₂, MgF₂ etc. can also self assemble into CCAs in a similar way.

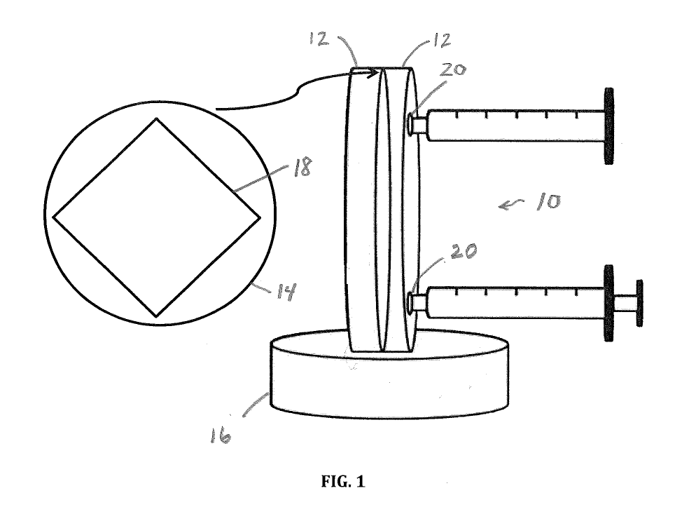

FIG. 1 shows an embodiment of a CCA filter device as a cell 10. Two fused silica quartz discs (2″ dia.× 3/16″) 12 were separated by a 125 μm thick Parafilm spacer (2″ dia.) 14 and mounted on a rotation stage 16. The Parafilm spacer 14 with an opening (1.2″×1.2″) 18 in the center is placed between two quartz discs 12. Other suitable spacings can also be used depending on the diffraction efficiency and bandwidth desired. The colloidal dispersion was injected into one of the two holes 20 to fill the cell 10. The system self assembled into a CCA. Any UV transparent materials can be used as the filter device windows as long as the two parallel flat surfaces are non-leeching of ionic species.

It is also contemplated that the CCA structure disclosed herein can be polymerized into a transparent hydrogel to form polymerized crystalline colloidal arrays (PCCA). This PCCA can be used as optical filters, separation devices and sensors in many applications. See Haacke et al. U.S. Pat. No. 5,266,238, Asher, S. A. et al., “Self Assembly Motif for Creating Submicron Periodic Materials. Polymerized Crystalline Colloidal Arrays”, J. Am. Chem. Soc., vol. 116 (1994), pp. 4997-4998, Liu L. et al., “Entropic Trapping of Macromolecules by Mesoscopic Periodic Voids in a Polymer Hydrogel”, Nature, vol. 397 (1999), pp. 141-144 and Holtz, J. H. et al., “Polymerized Colloidal Crystal Hydrogel Films as Intelligent Chemical Sensing Materials”, Nature, vol. 389 (1997), pp. 829-832. The patent and non-patent publications are incorporated in their entirety.

The center wavelengths rejected by the CCA filter at different incident glancing angles can be calculated by eqns. 1-2, where λ₀ is the wavelength in air diffracted by CCA which depends on the average refractive index of the CCA, n_{avg}, the lattice spacing, d, and the glancing angle θ. The glancing angle, θ in the colloidal medium is calculated from Snell's law for refraction, where θ₀ is the incident glancing angle in air. Wavelengths rejected by the filter can be easily tuned by changing incident angles or the concentration of particles in the CCA.

$$\begin{matrix}{λ}_{0} = 2 {n}_{avg} d sin θ & ( 1 ) \\ θ = {cos}^{- 1} [ \frac{cos {θ}_{0}}{{n}_{avg}} ] & ( 2 )\end{matrix}$$

In one embodiment, the band rejection wavelength of a highly charged silica CCA filter (volume percentage 7.0%, diameter of silica particles 47±5 nm) can be easily tuned from 237 nm to 227 nm by tilting the filter with respect to the incident beam. The full bandwidth, indicated by these measurements, is 6 nm to the 50% transmittance points and 1 nm to the 15% transmittance points for normal incidence. This full bandwidth is broader than the actual CCA bandwidth because the absorption spectrophotometer used here has a somewhat focused incident beam. The full bandwidth to the 50% transmission points determined from the measured Teflon Raman spectrum is only 4 nm. For use as a Rayleigh rejection filter, only half the full bandwidth limits transmission of the low frequency Raman spectra. The half bandwidth of the CCA diffraction band described herein is only 2 nm to the 50% transmission points (379 cm⁻¹ at 229 nm excitation wavelength).

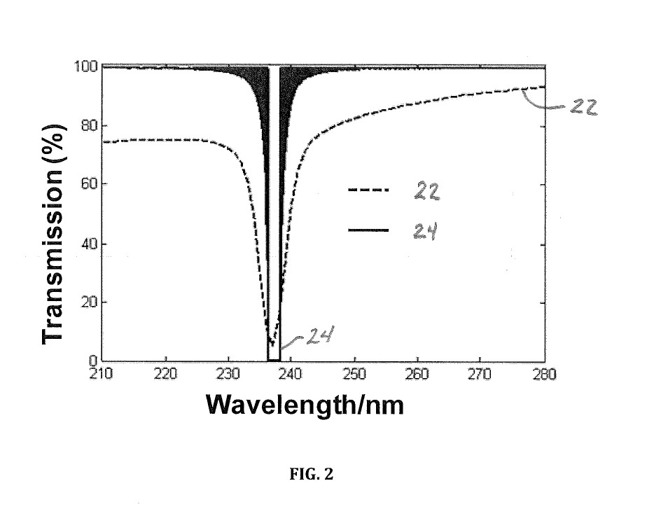

The width of the narrow wavelength band which is Bragg diffracted by the CCA filter depends on the degree of ordering of the charged silica particles within the CCA, the diameter of the particles, the thickness of the CCA and the difference between the refractive indices of the charged silica particles and the solvent. See Rundquist P. A. et al., “Dynamical Bragg Diffraction From Crystalline Colloidal Arrays”, J. Chem. Phys., vol. 91 (1989), pp. 4932-4941. The theoretical diffraction can be calculated by modeling the 3D CCA stack of (111) layers as a 1D stack of dielectric slabs. FIG. 2 illustrates observed and calculated light diffraction by silica CCA filters. The dashed line 22 shows the observed light diffraction while the solid line 24 shows the calculated light diffraction. For 1200 face-centered cubic (111) silica particle layers (101 μm total thickness), theory predicts a half full bandwidth of 1 nm to the 50% transmittance points and an ultra high attenuation at the Bragg diffracted wavelength with a transmission of ˜10⁻¹¹. See Tikhonov A. et al., “Light diffraction from colloidal crystals with low dielectric constant modulation: Simulations using single-scattering theory”, Phys. Rev. B, vol. 77 (2008), pp. 235404 and Yeh P. et al., “Electromagnetic propagation in periodic stratified media. I. General theory”, J. Opt. Soc. Am., vol. 67 (1977), pp. 423-438.

The use of small, low refractive index particles in non-closed-packed CCAs gives narrow bandwidth Bragg diffraction. The UV CCA filters made from these highly charged small silica particles are directly usable as filters to reject Rayleigh scattered light in UV Raman spectral measurements. No such notch filter for UV Raman spectroscopy has heretofore existed. In one embodiment, the highly charged silica CCA filter is used to reject the Rayleigh scattering and to acquire a Teflon UV Raman spectrum. The diameter of the silica particles used is 47±5 nm. The CCA filter rejects 99.82% (ratio of integrated areas) of the Rayleigh scattered light at 229 nm while transmitting the Raman bands of Teflon including the low frequency band at 290 cm⁻¹ (Δλ=1.53 nm).

In accordance with one embodiment, the CCA filter can be used as the wavelength selective optical element of a hyperspectral imaging device. For example, the optical devices described in Asher, U.S. Pat. No. 4,632,517 can be used for hyperspectral imaging system if the detectors are replaced by cameras (e.g. CCD or CMOS sensors or any other 2D array detectors).

In another embodiment of the hyperspectral imaging device, a collection optic would collect light emitted or scattered from a static object and would collimate it. The CCA diffracting optic would be placed in the collimated beam in order to diffract a narrow wavelength interval. A final optic would focus this diffracted collimated narrow band of light onto the image plane where a camera would be placed to record an image of the object over this narrow spectral interval.

The CCA would then be angle tuned to diffract adjacent spectral regions. The image obtained at each CCA angle would result from a different wavelength band. The collection of images of the static object over different wavelength bands constitutes a hyperspectral image data set. Each pixel in the image frame corresponds to a specific location on the object. The variation of the intensity for a given pixel over the wavelengths constitutes the Raman spectrum from that corresponding location on the object.

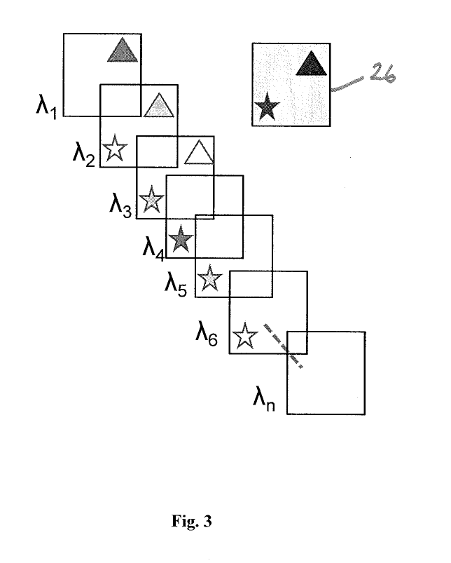

FIG. 3 illustrates a hyperspectral image data set of a static object 26 obtained by using a CCA to diffract a series of narrow wavelength bands λ₁ to λₙ. The CCA acts as a wavelength selecting optical element. The diffracted wavelength changes from wavelength λ₁ to λₙ by tuning the CCA diffracting angle. The image frames of the static object from wavelength λ₁ to λₙ are recorded by the camera. The different resulting images are exemplified by the selective appearance of the star and triangle evident at different wavelengths as shown in FIG. 3. The variation of the intensity for a given pixel at wavelengths between λ₁ to λₙ constitutes the spectrum from that of the corresponding location on the object.

The method of angle tuning of the CCA over a range of wavelengths can be used for Raman, luminescence, scattering, transmission, and reflected light hyperspectral imaging. Conversely, the CCA can be angle tuned to a specific wavelength and dynamic processes (e.g., chemical reactions, phase changes, or sample motion) can be monitored at specific wavelengths from the object's image.

Specifically, shifts of Raman or emission bands can be captured by hyperspectral imaging by using CCA filters to reveal molecular interactions and chemical environment (e.g., pH, ionic strength, dielectric constant). For instance, spectral images of biological cells could be used to study position dependent drug binding and to investigate the origin of toxicity of pharmaceuticals. The interaction of the pharmaceutical compound with the cell components can be detected through changes in bandwidth or frequencies in the compound's spectrum. Currently, integrated fluorescence images generated using wide bandpass filters contain no such spectral information; they show where the fluorescent probe is located but reveal nothing about molecular interactions or chemical environment. A CCA based spectral imaging device would make use of the currently used molecular probe's sensitivity to pH, ionic strength and even to the presence of specific ions manifested through changes in the probe's emission spectra.

The following examples are intended to illustrate the invention and should not be construed as limiting the invention in any way.

### Example 1

Charged silica particles were formed by attaching a high surface density of non UV light absorbing silane coupling agent (3-(trihydroxylsilyl)-1-propane-sulfonic acid, THOPS) to the surface of the small silica particles. A typical reaction used 5 mL tetraethoxysilane (TEOS, Fluka, Lot code 1332815 41207016) as the silica precursor, 8 mL ammonium hydroxide (29.40 wt %, J. T. Baker) as the catalyst, and 200 mL ethanol as the reaction solvent. The reaction mixture was stirred for 24 h. The resulting silica dispersion was filtered through a nylon mesh with 100 micron pore size. 200 mL of water was slowly added to the silica dispersion while stirring. The mixture was first heated to 50° C. for ˜30 min, then heated to 80° C. for ˜1 h. 6 mL of the silane coupling agent (3-(trihydroxylsilyl)-1-propane-sulfonic acid, THOPS, 30-35% in water, Gelest, Inc.) was adjusted to pH ˜6 by adding ammonium hydroxide and then added to the silica dispersion. The reaction was refluxed for 6 h at 80° C. Monodisperse silica particles had a diameter of 44±4 nm before surface modification. After attaching the silane groups to the silica surface, the charged silica particles had a diameter of 47±5 nm. The charged silica colloids were cleaned by centrifugation and redispersed in Nanopure water (Barnstead). Further purification was achieved by shaking the silica dispersion with mixed bed ion-exchange resin (Bio-Rad AG 501-X8). After purification, these highly charged silica particles self assembled into CCAs. The charged silica particles have 4740 charges per particle (0.616 charge/nm² or 9.86 μC/cm²) as determined by conductrometric titration with 0.01 N NaOH. The surface charge of the silica particles can be easily varied by changing the amount of THOPS added during surface modification.

### Example 2

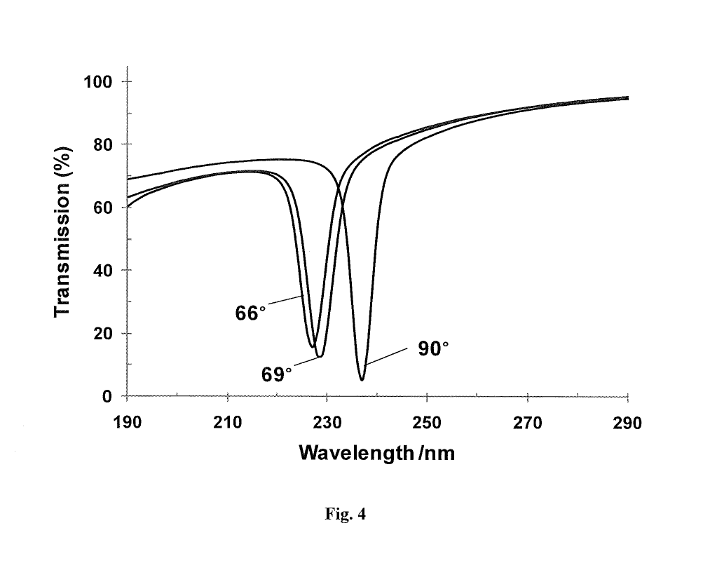

The Bragg diffracted wavelength of the CCA filter made from the highly charged silica particles (volume percentage 7.0%) from Example 1 can be easily tuned by changing the incident light glancing angle. FIG. 4 illustrates transmission spectra of the highly charged silica CCA filter for incident glancing angles of 90°, 69° and 66°. The band rejection wavelength can be easily tuned from 237 nm to 227 nm by tilting the filter with respect to the incident beam as shown in FIG. 4. The full bandwidth, indicated by these measurements, is 6 nm to the 50% transmittance points and 1 nm to the 15% transmittance points for normal incidence. This measured full bandwidth is broader than the true CCA bandwidth because the absorption spectrophotometer used has a weakly focused sampling beam. The full bandwidth to the 50% transmission points determined by a Teflon Raman measurement is only 4 nm. For a Rayleigh rejection filter, only half full bandwidth is involved in the long wavelength pass filter performance. The half full bandwidth of the CCA filter to the 50% transmission points is only 2 nm.

### Example 3

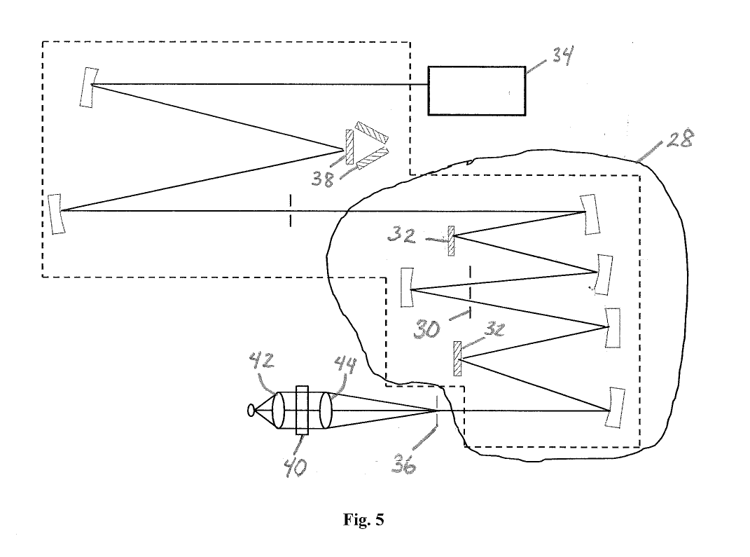

The highly charged silica CCA filter from Example 2 can be used to reject Rayleigh scattered light in UV Raman spectral measurements. A Teflon film was used as the sample for the Raman measurements. Raman spectra were excited with the 229 nm line (2 mW) from a continuous-wave UV Ar laser (Innova 300 FReD, Coherent Inc.). The schematic of the triple-stage monochromator and the CCA filter for Raman measurements for one embodiment is shown in FIG. 5. The spectrometer premonochromator 28 (illustrated as a double monochromator) having a bandpass slit 30 and gratings 32) was aligned to block most of the Rayleigh scattered light to avoid saturating the CCD camera 34. The embodiment shown has an entrance slit 36 and additional gratings 38. All optical elements of the spectrometer were identical for Raman spectra measured in the absence and presence of the CCA filter 40. The CCA filter 40 was placed between a collection 42 and imaging lens 44 where the light is collimated. Raman spectra of the Teflon were measured in the absence and presence of the CCA filter 40.

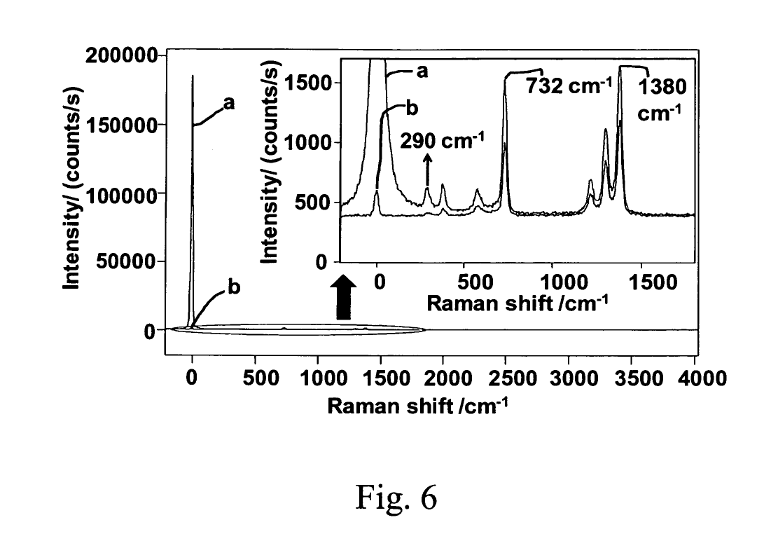

FIG. 6 shows two Raman spectra of Teflon, spectrum a shows the Raman spectrum without a CCA filter, while spectrum b shows the Raman spectrum with the CCA filter tuned to an angle that diffracts the Rayleigh scattered light. The inset in FIG. 6 expands the circled region. A high “Rayleigh peak” is observed in the Raman spectrum without a CCA filter. The Raman spectrum with the CCA filter shows the Teflon Raman spectrum measured using the CCA filter at an incident glancing angle of ˜69°. The CCA filter rejects 99.82% (ratio of integrated areas) of the Rayleigh scattered light at 229 nm while transmitting the Raman bands of Teflon including the low frequency band at 290 cm⁻¹.

### Example 4

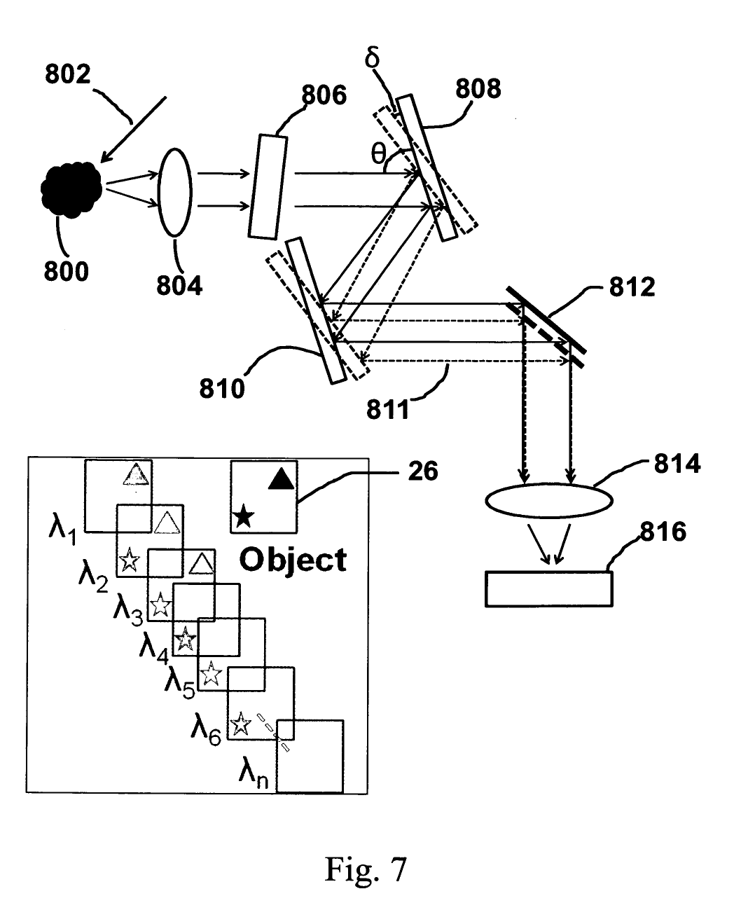

An embodiment of the hyperspectral imaging device utilizing a CCA deep UV wavelength selecting device that allows wavelength tuning with a stationary camera is shown in FIG. 7. A sample 800 is excited by monochromatic light 802. A collection element 804 collimates and directs the light to a Rayleigh rejection CCA filter 806. The Rayleigh rejection CCA filter 806 blocks the Rayleigh scattered light while passing the Raman scattered light. A wavelength selecting CCA filter 808 Bragg diffracts a specific narrow wavelength band of the collimated Raman scattered light and this collimated diffracted light is directed to a first high-reflectivity mirror 810 that is always parallel to the wavelength selecting CCA filter 808. The light reflected from the first high-reflectivity mirror 810 is parallel to the light incident to the wavelength selecting CCA filter 808. A second high-reflectivity mirror 812 is used to direct the light reflected from the first high-reflectivity mirror 810 to lens 814 that collects and focuses the light onto camera 816. The camera 816 is used to record and display the image of the sample in the narrow wavelength band selected. The wavelength selecting CCA filter 808 and the first high-reflectivity mirror 810 are rotatable and remain parallel to each other at all positions during the rotation. The light path is illustrated by the solid arrows in FIG. 7. After the rotation of the wavelength selecting CCA 808 and the first high-reflectivity mirror 810 by angle δ, the light path is illustrated by the dashed arrows 811. The light reflected from mirror 810 is parallel but is displaced. This displacement is compensated by translating the second high-reflectivity mirror 812 as the wavelength selecting CCA 808 and the first high-reflectivity mirror 810 are rotated to different angles. The amount of translation of the second high-reflectivity mirror 812 is related to the rotation angle δ, the original angle θ and the distance between the wavelength selecting CCA filter 808 and the first high-reflectivity mirror 810. The image obtained at each angle of the wavelength selecting CCA 808 is obtained at a different wavelength.

The collection of images of a static object over the different diffracted wavelength bands constitutes a hyperspectral image data set. Each pixel in the image frame corresponds to a specific location on the object. The variation of the intensity for a given pixel over a range of wavelengths constitutes the spectrum for the corresponding location on the object. Such a hyperspectral imaging device avoids the need for repositioning the camera 816 as the CCA imaging spectrometer is scanned through the wavelength range of interest.

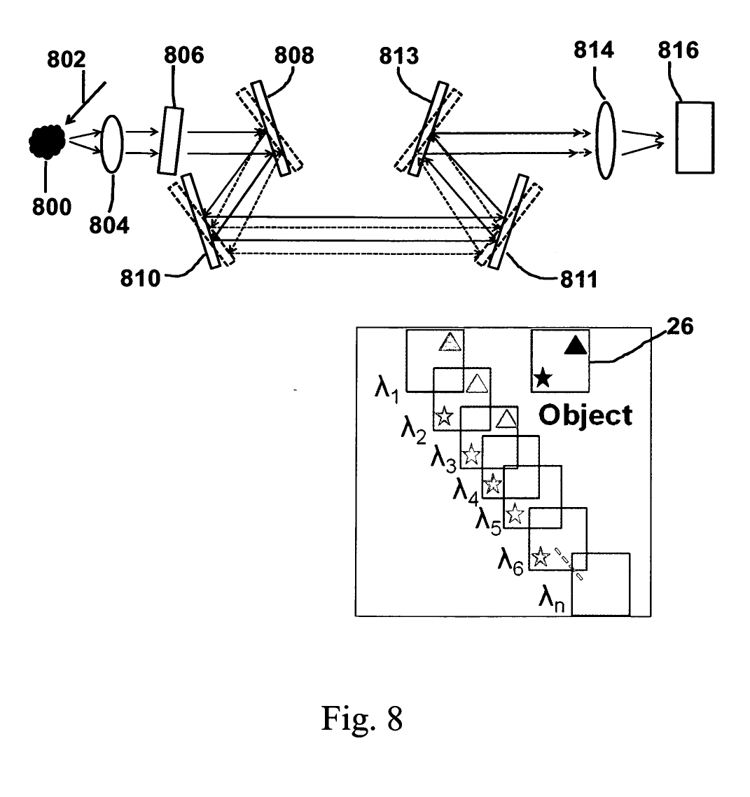

In some preferred embodiments, the second high-reflectivity mirror 812 can be replaced by a third and fourth high-reflectivity mirrors 811 and 813 as illustrated in FIG. 8. The mirrors 810, 811 and 813 and wavelength selecting CCA 808 are rotatable. The third and fourth high-reflectivity mirrors 811 and 813 are placed such that the displacement of the light after rotation can be compensated in the following way: the second and third high-reflectivity mirrors 811 and 813 are rotated by opposite angles to that of the first high-reflectivity mirror 810 and the wavelength selecting CCA 808 so that the mirrors 811 and 813 always reposition the light beam to be oriented exactly along the original incident beam to the wavelength selecting CCA 808 in order to avoid the need for repositioning the camera 816 as the wavelength selecting CCA 808 is scanned through the wavelength range of interest.

### Example 5

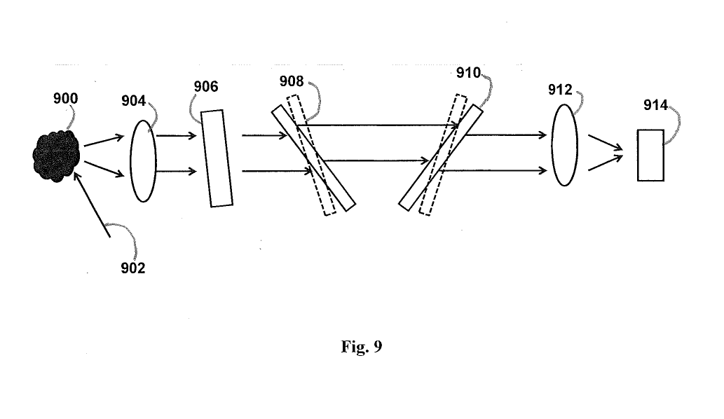

Another embodiment of the hyperspectral imaging spectrometer based on a CCA filter utilizes transmission through the CCA. Such a spectrometer is depicted in FIG. 9. A sample 900 is excited by monochromatic light 902. A collection element 904 collimates and directs the light to a Rayleigh rejection CCA filter 906. The Rayleigh rejection CCA filter 906 is oriented in the path of collimated collected light to reject the Rayleigh scattered light while transmitting the Raman scattered light. A rotatable wavelength selecting CCA 908 would transmit all of the Raman scattered light except for the narrow wavelength band determined by the orientation of the wavelength selecting CCA 908 with respect to the collimated light. A rotatable refractive index compensating device 910 is positioned at the mirror position of the wavelength selecting CCA 908 to compensate the displacement of the light beam caused by refraction. The transmitted Raman light is focused by an imaging optic 912 onto a camera 914 which records the image of the transmitted light.

The wavelength selecting CCA 908 is mounted and rotatable such that it can be angle tuned to diffract different wavelengths. The refractive index compensating device 910 is also rotatable and is rotated by opposite angle to that of the wavelength selecting CCA 908 so that the refractive index compensating device 910 always repositions the light beam to be exactly oriented along the original incident beam to the wavelength selecting CCA 908 in order to avoid repositioning camera 914 as the wavelength selecting CCA 908 is scanned through the wavelength range of interest.

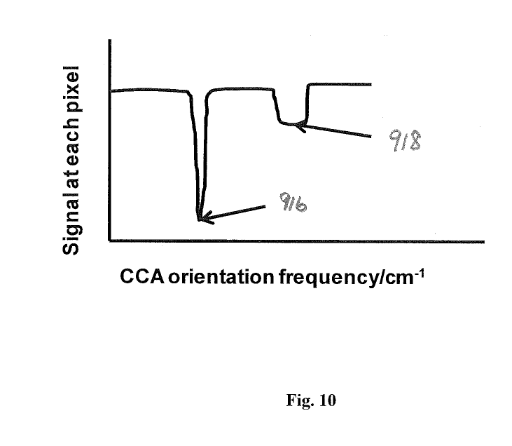

The operation of the spectrometer can be thought of as a “negative” of the aforementioned Bragg reflection imaging system to detect emitted or Raman scattered light. FIG. 10 illustrates a hypothetical “complementary” Raman spectrum of c-Si. The Raman spectrum of c-Si consists primarily of two bands, a first c-Si band at 520 cm⁻¹ 916 arising from a triply degenerate optical phonon and a second c-Si band at ˜980 cm⁻¹ 918 due to the second order optical phonon. The hyperspectral Raman image of a homogeneous Si chip can be acquired by the camera 914. The image intensity from Raman scattering is a function of the wavelength selecting CCA 908 orientation as controlled by the rotational stage. When the angle of the wavelength selecting CCA 908 is such that the Bragg reflection is tuned to a Raman shift of 520 cm⁻¹, the Raman scattered light from c-Si will not be transmitted and the signal will fall to a minimum at the first c-Si band at 520 cm⁻¹ 916, although not zero because the spectrum, in this case, consists of more than one band. For spectra with more bands, the signal will be attenuated for CCA filter orientations at each Raman band, in proportion to that particular band's Raman intensities.

Whereas particular aspects of the present invention and particular embodiments of the invention have been described above for purposes of illustration, it will be evident to those skilled in the art that numerous variations of the details of the present invention may be made without departing from the invention as described in the appended claims.

What is claimed is:

1. A method of making UV filter particles comprising:
a. selecting monodisperse particles comprised of a first material substantially transparent in the ultraviolet spectrum between about 190 and 300 nm wavelength;
b. attaching to the monodisperse particle surfaces a second compound substantially transparent in a portion of the ultraviolet spectrum below 300 nm wavelength, wherein the second compound provides charged groups, and the monodisperse particles after being attached to the second compound will have a charge density of at least 0.5 μC/cm², whereby forming the highly charged, surface functionalized particles substantially transparent in a portion of the ultraviolet spectrum below 300 nm wavelength.

2. The method of claim 1, wherein the monodisperse particles comprise silica.

3. The method of claim 2, further comprising the step of preparing monodisperse particles through hydrolysis and condensation of a silane precursor and a catalyst.

4. The method of claim 3, wherein the second compound comprises a silanol having one or more hydroxyl groups bonded to the silica monodisperse particles.

5. The method of claim 3, wherein the second compound comprises 3-(trihydroxysilyl)-1-propane-sulfonic acid.

6. The method of claim 1, wherein the monodisperse particles comprise calcium fluoride.

7. The method of claim 1, wherein the monodisperse particles comprise magnesium fluoride.

8. The method of claim 1, wherein the highly charged, surface functionalized particles have an average diameter of equal or greater than 10 nm and equal or less than 300 nm.

9. The method of claim 1 further comprising the steps of:
a. cleaning the highly charged, surface functionalized particles by cleaning means to remove impurities;
b. treating the cleaned particles with ion exchange resin to further clean them; and
c. self-assembling the resin treated particles, whereby a crystalline colloidal array is formed.

10. The method of claim 9, wherein the cleaning means comprises centrifugation and redispersion.

11. The method of claim 9, wherein the cleaning means is dialysis.

12. The method of claim 9, further comprising the step of transferring the crystalline colloidal array to a cell, wherein the cell comprises parallel wall members formed of a material substantially transparent in a portion of the ultraviolet spectrum between about 190 and 300 nm wavelength.

13. The method of claim 12, further comprising the steps of:
a. passing a beam of ultraviolet light through the cell;
b. observing diffraction of ultraviolet light from the crystalline colloidal array;
c. rotating the cell.

14. The method of claim 9, further comprising the step of polymerizing the crystalline colloidal array and a monomer into a polymer, wherein the polymer formed is substantially transparent in the ultraviolet spectrum between about 190 and 300 nm wavelength.

15. UV filter particles comprising:
a. a core of a first material substantially transparent in a portion of the ultraviolet spectrum between about 190 and 300 nm wavelength;
b. a surface functionalization substantially transparent in a portion of the ultraviolet spectrum between about 190 and 300 nm wavelength on the surface of the core, the functionalized surface having a charge of at least 0.5 μC/cm²; and
c. wherein the surface functionalized core particles have an average diameter of between approximately 10 nm and 300 nm.

16. The UV filter particles of claim 15 wherein the cores are comprised of silica.

17. The UV filter particles of claim 15 wherein the cores are comprised of magnesium fluoride.

18. The UV filter particles of claim 15 wherein the cores are comprised of calcium fluoride.

19. A hyperspectral imaging device for imaging the Raman scattered light and/or emission light of a selected sample, comprising:
a. a beam of incident radiation;
b. a diffraction element positioned in the path of said beam of incident radiation, said diffraction element comprising a crystalline colloidal array structure substantially transparent in a portion of the ultraviolet spectrum between about 190 and 300 nm wavelength, the diffraction element having a pair of substantially planar and parallel outer surfaces positioned at a predetermined angle to said path of said beam of incident radiation to diffract a narrow wavelength band of said beam of incident radiation;
c. an optic that collects and focuses said narrow wavelength band of incident radiation to form an image on a camera to record an image of said selected sample at said narrow wavelength band.

20. The hyperspectral imaging device as set forth in claim 19, wherein said narrow wavelength band of said beam of incident radiation is tunable by mounting said diffraction element on a rotational stage to alter said predetermined angle to said beam of incident radiation and said optic and said camera are moved to new positions to record said images of said selected sample at said different narrow wavelength bands.

21. The hyperspectral imaging device as set forth in claim 19, wherein said camera is from the group consisting of a CCD camera, a CMOS sensor, or a 2D array detector.

22. The hyperspectral imaging device as set forth in claim 19, wherein said diffraction element comprises transparent cell means for housing said crystalline colloidal array structure, said cell means including an exterior surface which is nonparallel to said outer surfaces of said crystalline colloidal array structure, cell means further comprising a material having a refractive index similar to the refractive index of said crystalline colloidal array structure.

23. A hyperspectral imaging device comprising:
a. monochromatic light directed toward a sample to produce at least one of Rayleigh scattered light, Raman scattered and/or emission light;
b. an optical collection element that collects and collimates Rayleigh scattered light, Raman scattered light and/or emission light from said sample;
c. a Rayleigh rejection crystalline colloidal array filter placed in the collimated light beam to block the Rayleigh scattered light while transmitting the Raman and/or emission light;
d. a wavelength selecting crystalline colloidal array positioned in the path of said Raman and/or emission light at an angle to said path of said Raman and/or emission light to diffract a particular narrow wavelength band of said Raman and/or emission light;
e. a first high-reflectivity mirror positioned in the path of said particular narrow wavelength band to reflect said particular narrow wavelength band from said wavelength selecting crystalline colloidal array, wherein said first high-reflectivity mirror is parallel to said wavelength selecting crystalline colloidal array;
f. a second high-reflectivity mirror that directs the light reflected from said first high-reflectivity mirror to an optic, wherein said second high-reflectivity mirror can be translated to compensate the displacement of the light beam as said wavelength selecting crystalline colloidal array and said first high-reflectivity mirror are rotated to different angles such that the light beam is always oriented to the same positions on said optic that focuses and directs the light beam to a camera;
g. said camera positioned to record an image of said sample at said particular diffracted narrow wavelength.

24. The hyperspectral imaging device as set forth in claim 23, wherein said camera comprises a CCD camera or CMOS sensor or any other 2D array detector.

25. The hyperspectral imaging device as set forth in claim 23, wherein said wavelength selecting crystalline colloidal array is mounted on a first rotational stage to alter said angles to said path of said Raman and/or emission light for diffracting different narrow wavelength bands of said Raman and/or emission light; said first high-reflectivity mirror is mounted on a second rotational stage and is parallel to said wavelength selecting crystalline colloidal array at all positions; said second high-reflectivity mirror is translated to corresponding positions such that the light reflected from said second high-reflectivity mirror is directed to the same positions on said optic lens and said camera does not need to move to record the images of said sample over said different narrow wavelength bands as said wavelength selecting crystalline colloidal array and said first high-reflectivity mirror are angle-tuned.

26. The hyperspectral imaging device as set forth in claim 23, further comprising a third high-reflectivity mirror; said second and third high-reflectivity mirrors are rotated by the same angle but in the opposite directions as that of said first high-reflectivity mirror and said wavelength selecting crystalline colloidal array such that the reflected beam from said second high-reflectivity mirror is oriented along the original incident beam to said wavelength selecting crystalline colloidal array to avoid the need for repositioning said camera as said wavelength selecting crystalline colloidal array is angle scanned through the wavelength range of interest.

27. A transmission hyperspectral imaging device comprising:
a. monochromatic light directed toward a sample to produce at least one of Rayleigh scattered light, Raman scattered light and/or emission light;
b. an optical collection element that collects and collimates Rayleigh scattered light, Raman scattered light and/or emission light from said sample;
c. a Rayleigh rejection crystalline colloidal array filter placed in the collimated light to block Rayleigh scattered light from said sample while transmitting the Raman and/or emission light;
d. a wavelength selecting crystalline colloidal array positioned in the path of said Raman and/or emission light at an angle to said path of said Raman and/or emission light to diffract a narrow wavelength band of said Raman and/or emission light while transmitting other Raman and/or emission light;
e. a refractive index compensating device positioned at the mirror angle position of said wavelength selecting crystalline colloidal array to compensate the displacement of the light beam caused by refraction.
f. an optic positioned to focus Raman and/or emission light transmitted through said crystalline colloidal array and said refractive index compensating device;
g. a camera positioned to record an image of said Raman and/or emission light from said optic.

28. The transmission hyperspectral imaging device as set forth in claim 27, wherein said wavelength selecting crystalline colloidal array is mounted on a first rotational stage to alter said angles to diffract different narrow wavelength bands of said Raman and/or emission light and said refractive index compensating device is mounted on a second rotational stage rotated in the opposite angle direction to that of said wavelength selecting crystalline colloidal array such that said refractive index compensating device is oriented to compensate the displacement of the light beam caused by refraction.

29. The transmission hyperspectral imaging device as set forth in claim 27, wherein said camera comprises a CCD camera or CMOS sensor or any other 2D array detector.
